(19) United States
(12) Patent Application Publication
(10) Pub. No.: US 2008/0220685 A1
(43) Pub. Date: Sep. 11, 2008

(54) Interleaved Electrodes In A Passive Matrix Display

(75) Inventors: Mark Thomas Johnson, Eindhoven (NL); Eliav Itzhak Haskal, Eindhoven (NL); Alan George Knapp, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,751

(22) PCT Filed: Dec. 23, 2005
(86) PCT No.: PCT/IB05/54391

§ 371 Date: Jun. 25, 2007

(30) Foreign Application Priority Data
Jan. 7, 2005 (EP) 05100067.7

(51) Int. Cl. H01J 1/53; G09G 3/00

(52) U.S. Cl. 445/46; 345/84

(57) ABSTRACT

A passive matrix in-plane switching bi-stable display (1) has first and second electrodes (20, 30), and pixels (10) associated with intersections of the first electrodes (20) and the second electrodes (30). The display (1) comprises on a same substrate both the first electrodes (20) and, per pixel (10), a first group of electrodes (G1) interleaving with a second group of electrodes (G2). The electrodes of the first and second group (G1, G2) extend in a same first direction, and are displaced with respect to each other in the first direction to obtain in the first direction a first area (A1) where only electrodes of said first group (G1) are present, a second area (A2) where only electrodes of said second group (G2) are present, and a third area (A3) in-between the first and the second area (A1, A2) where both electrodes of said first and second group (G1, G2) are present. Insulating areas (40) are present at least at crossing positions where the second electrodes (30) have to cross the first electrodes (20). The second electrodes (30) extend in a second direction and are positioned for crossing the first electrodes (20) at the crossing positions and for contacting the second group of electrodes (G2) in the second area (A2). Sub-electrodes (S1) per pixel (10) are arranged in the second direction to interconnect the first group of electrodes (G1) in the first area and to connect said first group (G1) to an associated one of the first electrodes (20).

The invention relates to a method of manufacturing an interleaving electrode structure for pixels of a passive matrix in-plane switching bi-stable display, and to a passive matrix in-plane switching bi-stable display with an interleaved electrode structure per pixel.

JP-A-2002-311461 discloses an in-plane switching electrophoretic display in which the particles move in parallel with respect to the substrate when an electric field is generated by the electrodes. In FIG. 33, a few pixels of a matrix display are shown. Each of the pixels has a pixel electrode, and a non-pixel electrode. The non-pixel electrodes are line shaped and extend in the row direction. The rectangular pixel electrodes are interconnected in the column direction. These connections between the pixel electrodes cross the non-pixel electrodes. FIG. 31 of this prior art shows a cross-section of a pixel from which it becomes clear that both the non-pixel electrodes and the pixel electrodes are situated at the same side of the cell volumes wherein the particles are present, such that an in-plane field is generated in the cell volumes. This prior art has the drawback that the electrical field generated is relatively weak, especially in larger pixels.

JP-A-2002-169191 discloses an electrophoretic display in which the particles can be moved in-plane and in the direction perpendicular to the in-plane direction. The display cells comprise a pixel volume which comprises the particles. A display lateral electrode is present at one side of the display volume, an interleaving inner side electrode and ground electrode are present at the opposite side of the display volume. The in-plane movement of the particles is obtained by a suitable voltage between the inner side electrode and the ground electrode. To be able to select the pixels of the matrix separately, crossing electrodes are required. In this display, the display lateral electrodes extend in the column direction which is perpendicular to the row direction in which are situated the connection lines which interconnect the inner side electrodes and which interconnect the ground electrodes of the pixels. Thus, although this prior art shows interleaving electrodes which are positioned at the same side of the display volume to generate the in-plane field, these electrodes do not cross each other.

It is an object of the invention to provide an easy to manufacture layout for an interleaved electrode structure per pixel to generate an in-plane field wherein these electrodes cross each other.

A first aspect of the invention provides a method of manufacturing as is claimed in claim 1. A second aspect provides a passive matrix in-plane switching bi-stable display as is claimed in claim 12. Advantageous embodiments are defined in the dependent claims.

The method in accordance with the first aspect of the invention provides a passive matrix in-plane switching bi-stable display of which per pixels a first and a second group of interleaving electrodes is present. The display has crossing first and second electrodes. The pixels are associated with intersections of the first electrodes and the second electrodes. The first electrode should be electrically connected to the first group of electrodes, the second electrode should be electrically connected to the second group of electrodes.

The first electrodes, the first group of electrodes and the second group of electrodes are provided on a same substrate. The elongate electrodes of both the first and second group extend in a same first direction, and are displaced with respect to each other in the first direction to obtain in the first direction a first area where only electrodes of said first group are present, a second area where only electrodes of said second group are present, and a third area in-between the first and the second area where both electrodes of said first and second group are present.

An insulator is provided at least at crossing positions where the second electrodes have to cross the first electrodes. The second electrodes each extending in a second direction are positioned for crossing the crossing positions and contacting the second group of interleaved electrodes in the second area.

The first group of interleaved electrodes is connected per pixel to the first electrodes either during the step wherein the first group of electrodes are provided or during the step during which the second electrodes are provided by providing sub-electrodes per pixel in the second direction which interconnect the first group of interleaved electrodes in the first area and which connect said interconnected first group to an associated one of the first electrodes.

In an embodiment in accordance with the invention, the insulator is provided on the first electrodes and the second electrodes are provided on the second group of electrodes and on the insulator, all on the same substrate. Also the sub-electrodes are present on the first substrate, and may be provided either together with the first group of electrodes or together with the second electrodes.

In another embodiment, the second electrodes are provided on another substrate than the first electrodes, the first group of electrodes and the second group of electrodes. Now, the insulator may be provided on the first electrodes at least the crossing positions or on the second electrodes at least the crossing positions. Also the sub-electrodes may be provided together with the first group of electrodes on the first mentioned substrate, or together with the second electrodes on the another substrate. The contacting of the second electrode with the second group of electrodes, and if relevant of the sub-electrodes with the first group of electrodes occurs when the first mentioned and the another substrate are stacked.

In an embodiment in accordance with the invention, the step of providing the sub-electrodes per pixel is applied during the step wherein the first and second group of electrodes are provided. During this step the sub-electrodes are provided on the substrate to obtain one structure with the electrodes of said first group and the associated one of the first electrodes. Thus, the first group of electrodes is interconnected in the first area and no crossings with the second electrodes are required. This interconnection can easily be extended up to the associated first electrode to connect the interconnected first group of electrodes to the associated first electrode without crossing the second electrode.

In an embodiment in accordance with the invention, the step of providing said first group of electrodes provides a first group of electrodes being parallel arranged line shaped sections only, and the step of providing the sub-electrodes per pixel is applied during the step of providing the second electrodes by providing the sub-electrodes in the first area to electrically interconnect the parallel arranged line shaped sections, and to electrically connect the interconnected parallel arranged line shaped sections to the associated one of the first electrodes. Again, the first group of electrodes is interconnect and connected to the associated first electrode in the first area without having to cross the second electrodes. The parallel arranged line shaped sections are especially easy to manufacture, for example with a roll-to-roll process.

In an embodiment in accordance with the invention, a dimension of the first area in the first direction is larger than a width of an associated one of the sub-electrodes. This allows for tolerance of the position of the sub-electrodes. This tolerance is especially relevant if the sub-electrodes are not provided in the same step as the first group of electrodes.

In an embodiment in accordance with the invention, the step of providing said second group of electrodes is applied during the step wherein the first and second group of electrodes are provided by providing said second group of electrodes together with a section which extends in the second direction and which is located in the second area to obtain, per pixel, one structure with the electrodes of said second group. The section does not extent so far as to electrically connect the associated one of the first electrodes. The associated one of the second electrodes provided during the step of providing the second electrodes contacts said section. Thus, the second group of electrodes is provided as a comb shaped interconnect group in one manufacturing step. The connection with the associated second electrode is obtained when this second electrode is provided in an electrically connecting manner in a later step on top of the interconnecting section.

In an embodiment in accordance with the invention, a width of the interconnecting section in the first direction is larger than a width of an associated one of the second electrodes. This allows for tolerance of the position of the second electrodes with respect to the interconnecting section, which facilitates an easy manufacturing because the second electrodes are provided in a later step than the interconnecting section.

In an embodiment in accordance with the invention, the step of providing the second group of electrodes provides a second group of electrodes which are parallel arranged line shaped sections only. In the later step, the second electrodes are provided to contact the parallel arranged line shaped sections in the second area. The parallel arranged line shaped sections are especially easy to manufacture, for example with a roll-to-roll process.

In an embodiment in accordance with the invention, a dimension of the second area in the first direction is larger than a width of an associated one of the second electrodes. It is now easier to reliably interconnect the parallel arranged line shaped sections with the second electrode even if the position of the second electrode in the first direction has some tolerance.

These and other aspects of the invention are apparent from and will be elucidated with reference to the embodiments described hereinafter.

In the drawings:

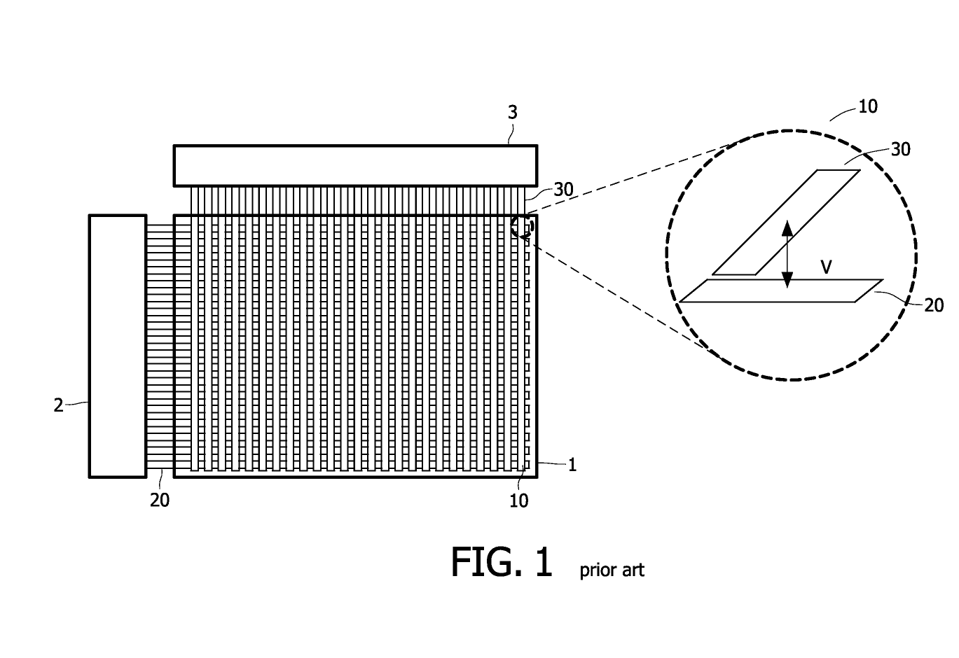

FIG. 1 schematically shows a prior art passive matrix display layout wherein a perpendicular electric field is generated between crossing top and bottom electrodes,

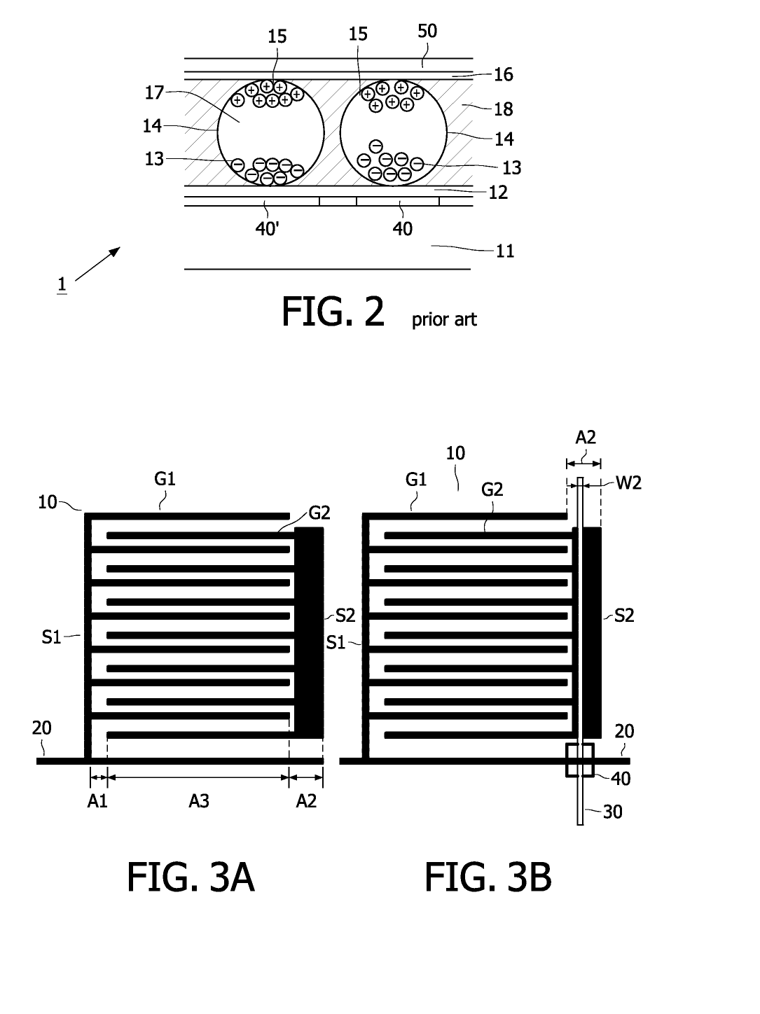

FIG. 2 shows a cross-section of part of a prior art electrophoretic display,

FIGS. 3A and 3B show an interleaving electrode structure for a pixel of the passive matrix bi-stable display in accordance with an embodiment of the invention,

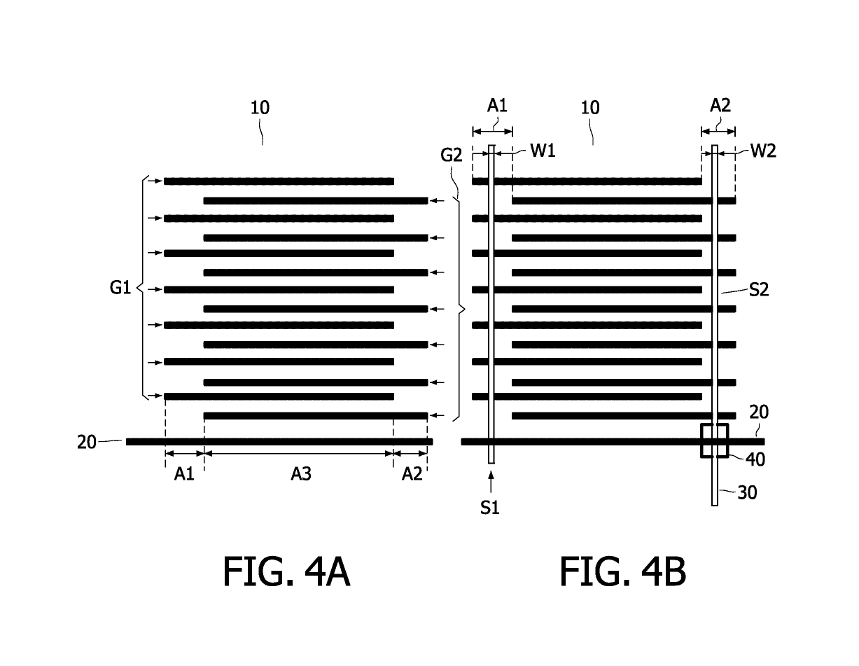

FIGS. 4A and 4B show an interleaving electrode structure for a pixel of the passive matrix bi-stable display in accordance with another embodiment of the invention,

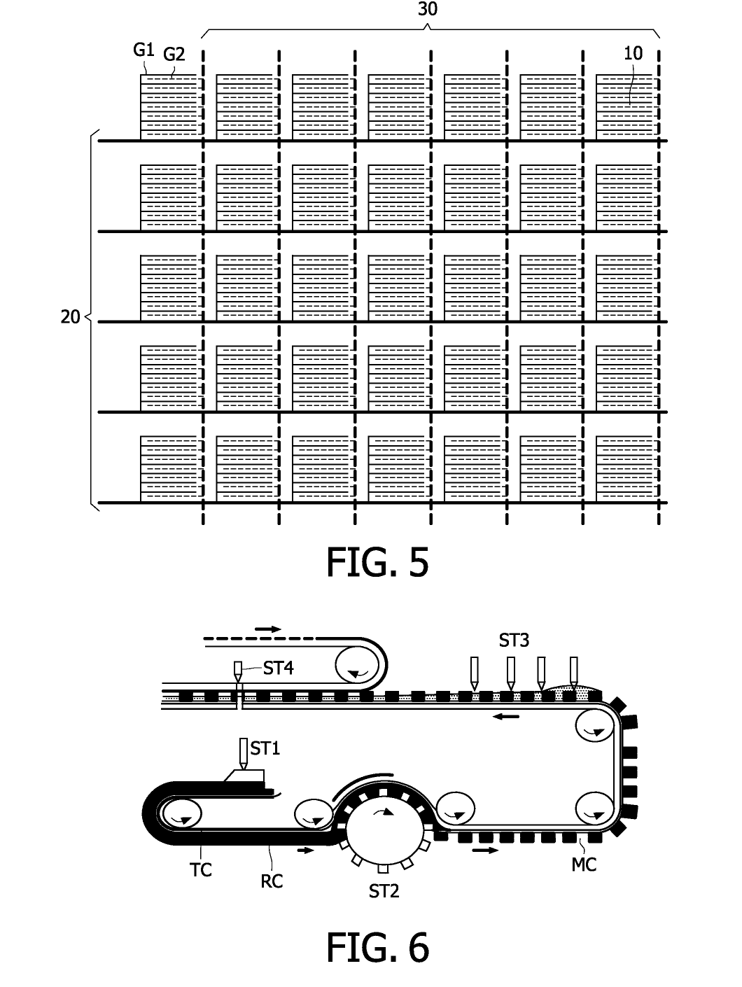

FIG. 5 schematically shows an array of pixels in accordance with an embodiment of the invention, and

FIG. 6 schematically shows a roll-to-roll manufacturing process.

FIG. 1 schematically shows a prior art passive matrix display layout wherein a perpendicular electric field is generated between crossing top electrodes 30 and bottom electrodes 20. Traditionally, passive matrix displays use an electrode structure which comprises a set of parallel arranged first electrodes 20 which perpendicularly cross parallel arranged second electrodes 30. The optical state of the display material which is present in the pixels 10, which are located in-between the intersections of the first and the second electrodes, depends on a voltage V applied between the associated first and second electrodes. In a bi-stable display, this display material has bi-stable properties. At least two stable optical states exist which are kept during a relatively long period in time without requiring a voltage across the material. An example of a bi-stable material is electrophoretic material.

The enlarged section at the top right side of the display 1 shows the crossing top electrode 30 and bottom electrode 20 for a single pixel 10. A first driver 2 is connected to the bottom electrodes 20, and a second driver 3 is connected to the top electrodes 30. Usually, the first driver 2 is referred to as the select driver and the second driver 3 is referred to as the data driver. The first electrodes 20 are also referred to as the select electrodes, row electrodes or bottom electrodes. The second electrodes 30 are also referred to as the data electrodes, the column electrodes or top electrodes. Alternatively, the data electrodes 30 may extend in the row direction and the select electrodes 20 may extend in the column direction and/or the select electrodes may be the top electrodes and the data electrodes may be the bottom electrodes. The select driver 2 and the data driver 3 are controlled such that the select driver 2 supplies suitable select voltages to the select electrodes 20 such that only a single row of pixels 10 is sensitive to the data voltages supplied by the data driver 3 in parallel to the data electrodes 30. A complete image can be written into the display 1 by sequentially selecting the rows of pixels one by one while supplying the data voltages in parallel to the pixels 10 of the selected row.

In this prior art layout, the bi-stable material is present in-between the electrodes 20 and 30 which create an electrical field which is perpendicular to the plane of the display 1. This layout is not suitable for in-plane switching of the bi-stable material wherein an electrical field has to be generated which is parallel to the plane of the display 1. In order to create an in-plane electric field, the electrodes within a pixel 10 must be situated adjacent to each other in the plane of the display, preferably at the same side of the bi-stable material.

FIG. 2 shows a cross-section of part of a prior art electrophoretic display 1 which, for elucidation only, has the size of a few display elements only. The electrophoretic display device 1 comprises a base substrate 11, an electrophoretic film with an electronic ink which is present between two transparent substrates 12 and 16 which, for example, are of polyethylene. One of the substrates 12 is provided with transparent picture electrodes 40, 40′, and the other substrate 16 with a transparent counter electrode 50. The picture electrodes 40, 40′ are the top electrodes 20 which are now situated at the bottom of the display 1. The counter electrode 50 comprises the bottom electrodes 30 of FIG. 1 which now are present on the top of the display 1 and which cross the picture electrodes 40, 40′ perpendicularly.

The electronic ink comprises multiple micro capsules 14, of about 10 to 50 microns. The microcapsules 14 need not be ball-shaped, any other shape, such as for example, predominantly rectangular, is possible. Each micro capsule 14 comprises positively charged black particles 15 and negative charged white particles 13 suspended in a fluid 17. The dashed material 18 is a polymeric binder. The particles 13 and 15 may have other colours than black and white. It is only important that the two types of particles 13, 15 have different optical properties and act differently to an applied electric field. Usually, the particles 13, 15 are oppositely charged. The layer 12 is not necessary, or could be a glue layer. When a negative voltage is applied to the counter electrode 50 with respect to the picture electrodes 40, 40′, an electric field is generated which moves the black particles 15 to the side of the micro capsule 14 directed to the counter electrode 50. Simultaneously, the white particles 13 move to the opposite side of the microcapsule 14 where they are hidden to the viewer and the display element will appear dark to a viewer. By applying a positive field between the counter electrodes 50 and the picture electrodes 40, 40′, the white particles 13 move to the side of the micro capsule 14 directed to the counter electrode 50 and the display element will appear white to a viewer (not shown). When the electric field is removed the particles 13, 15 remain in the acquired state, the display exhibits a bi-stable character and consumes substantially no power.

Although in FIG. 2 one micro capsule 14 relates with one of the picture electrodes 40, 40′, in a practical embodiment, many micro capsules 14 may relate with one of the picture electrodes 40, 40′.

FIGS. 3A and 3B show an interleaving electrode structure for a pixel of the passive matrix bi-stable display 1 in accordance with an embodiment of the invention. FIG. 3A shows the electrodes present at a particular instant during the manufacturing of the display 1. FIG. 3B shows the electrodes present at a later instant during the manufacturing of the display 1.

In FIG. 3A, both the first group of electrodes G1, the sub-electrode S1, the second group of electrodes G2, the section S2, and the first electrodes 20 are provided on a substrate (not shown) in the same manufacturing step. The first group of electrodes G1 comprises line segments which extend in the first direction which in FIGS. 3A and 3B is the horizontal direction. The second group of electrodes G2 comprises line segments which also extend in the first direction. The electrodes of the first and second group interleave each other in a second direction which in FIGS. 3A and 3B is the vertical direction. The first group of electrodes G1 and the second group of electrodes G2 are displaced with respect to each other in the first direction to obtain a first area A1 (in FIGS. 3A and 3B, at the left hand of the pixel 10) wherein only electrodes of the first group G1 are present, a second area A2 (in FIGS. 3A and 3B at the right hand of the pixel 10) wherein only electrodes of the second group G2 are present, and a third area A3 in-between the first area A1 and the second area A2 wherein both the electrodes of the first group G1 and the electrodes of the second group G2 are present.

The electrodes of the first group G1 are electrically interconnected in the first area A1 by the sub-electrode S1 which extends in the second direction. This sub-electrode S1 extends up to the first electrode 20 associated with the pixel 10 to electrically connect the first group of electrodes G1 of this pixel 10 to the first electrode 20. The electrodes of the second group G2 are electrically interconnected in the second area A2 by the section S2 which extends in the second direction.

In FIG. 3B, on top of the structure of FIG. 3A, first an insulator 40 is provided on the first electrode 20 at a position where the second electrode 30 has to cross the first electrode 20. Usually, this position lies in the direction of an extension of the section S2. Secondly, the second electrode 30 is provided on the section S2 to electrically contact this section S2. The second electrode 30 crosses the first electrode 20 on top of the insulator 40 such that the second electrode 30 is electrically separated from the first electrode 20. Preferably, the width of the section S2 in the first direction is larger than the width W2 of the section S2. The position of the second electrode 30 which is provided in another step than the section S2 in the first direction may be positioned with a greater tolerance. This allows for a cheap manufacturing process.

These interleaved first electrodes G1 and second electrodes G2 generate an in-plane electrical field if a voltage difference is present therein between the first electrode 20 and the second electrode 30. The interleaved structures per pixel 10 are obtained while the first electrodes 20 and the second electrodes 30 require a single crossover only.

Many alternative layouts are possible, for example, the first and second electrodes may cross each other with an angle which deviates from 90 degrees, or the first and the second electrodes may be interchanged. The insulator 40 may, for example, cover the complete first electrode 20. Such a pixel structure is particularly advantageous because it is possible to scale the dimensions of the pixel 10 whilst maintaining the same performance. Only the spacing between the electrodes has to be kept the same.

It has to be noted that all the electrodes G1, G2, S2, S1, 20, 30 and the insulator 40 may be provided on a same substrate. Alternatively, it is possible to provide the electrodes structure shown in FIG. 3A on one substrate and the second electrode 30 together with the insulator 40 on a second substrate. The insulator 40 may instead be provided on the first electrode on the first substrate. Also the relatively wide vertical section S2 which is now provided on the first substrate may be provided on the second substrate as a separate section on the second electrode 30, or may be the second electrode 30 which may be locally widened (as is shown in FIGS. 4A and 4B). Now, the electrodes G2 should sufficiently far extend into the second area A2. However, at least the horizontal interleaving line portions of the first and the second group G1, G2 and the first electrodes 20 should be provided on the same substrate and preferably in a same process step.

FIGS. 4A and 4B show an interleaving electrode structure for a pixel of the passive matrix bi-stable display in accordance with another embodiment of the invention. FIG. 4A shows the electrodes present at a particular instant during the manufacturing of the display 1. FIG. 4B shows the electrodes present at a later instant during the manufacturing of the display 1.

In FIG. 4A, the first group of electrodes G1, the second group of electrodes G2, and the first electrodes 20 are provided on a substrate (not shown) during the same manufacturing step. The first group of electrodes G1 is formed by line segments which extend in the first direction which in FIGS. 4A and 4B is the horizontal direction. The second group of electrodes G2 is formed by line segments which also extend in the first direction. The electrodes of the first and second group are interleaved in a second direction which is in FIGS. 4A and 4B the vertical direction. The first group of electrodes G1 and the second group of electrodes G2 are displaced with respect to each other in the first direction to obtain a first area A1 (in FIGS. 4A and 4B, at the left hand of the pixel 10) wherein only electrodes of the first group G1 are present, a second area A2 (in FIGS. 4A and 4B at the right hand of the pixel 10) wherein only electrodes of the second group G2 are present, and a third area A3 in-between the first area A1 and the second area A2 wherein both the electrodes of the first group G1 and the electrodes of the second group G2 are present.

After this manufacturing step, the electrodes of both the first group G1 and the second group G2 are not yet electrically interconnected. Because all the lines of the first group G1 and of the second group G2, and the first electrodes 20 all extend in the same first direction, it is possible to provide these lines at distances which have a high accuracy with a relatively simple single process step, for example in a roll-to-roll manufacturing process.

In FIG. 4B, on top of the structure of FIG. 4A, first an insulator 40 is provided on the first electrode 20 at a position where the second electrode 30 has to cross the first electrode 20. Secondly, both the sub-electrode S1 and the second electrode 30 are provided. The sub-electrode S1 is provided in the first area A1 to interconnect the horizontal line segments of the first group G1 and to connect these interconnected horizontal line segments to the first electrode 20. The sub-electrode S1 should not extend beyond the pixel 10, thus each pixel 10 has its own sub-electrode S1 which is not interconnected to other sub-electrodes S1. The second electrode 30 is provided in the second area A2 to interconnect the horizontal line segments of the second group G2. Thus now, the second electrode forms the segment S2 shown in FIG. 3B. The second electrode 30 crosses the first electrode 20 on top of the insulator 40 such that the second electrode 30 is electrically separated from the first electrode 20. Preferably, the width of the area A1 in the first direction is larger than the width W1 of the first electrode 20, and the width of the area A2 in the first direction is larger than the width W2 of the second electrode 30. Now, the position of the sub-electrode S1 and the second electrode 30 which together are provided in another step than the interleaving line segments G1 and G2 and the first electrodes 20 may be positioned with a greater tolerance. This allows for a cheap manufacturing process. Both the first and the second electrodes 20, extend along several pixels 10. Usually the first and second electrodes 20, 30 extend along the complete line of pixels 10 between side edges of the display 1.

Again, many alternative layouts are possible, for example, the first and second electrodes may cross each other with an angle which deviates from 90 degrees, or the first and the second electrodes may be interchanged.

It has to be noted that the electrodes shown in FIG. 4A should be present on the same substrate. The insulator 40 may be provided on the first electrodes 20, and also the segments S1, and the second electrodes 30 may be provided on this same substrate. It is however also possible to provide the second electrodes 30 and/or the segments S1 on a second substrate. Now, the insulator 40 may be provided on the first electrodes 20 or on the second electrodes 30. Again, the contacting is obtained by stacking the first and the second substrate.

FIG. 5 schematically shows an array of pixels in accordance with an embodiment of the invention. The structure of the pixels 10 which comprise the interleaving first and second group of electrodes G1 and G2, is either identical to that shown in FIG. 3B or to that shown in FIG. 4B or to an alternative thereof. FIG. 5 clearly shows the first electrodes 20 which cross the second electrodes 30. Both the first electrodes 20 and the second electrodes are associated with a plurality of pixels, which in FIG. 5 extend along a line in the horizontal and vertical direction, respectively. The interleaving electrodes of the first and second group G1 and G2 occur for each pixel 10.

FIG. 6 schematically shows a roll-to-roll manufacturing process. Such a roll-to-roll manufacturing process for the manufacture of an electrophoretic display is for example known from the publication “Microcup Electrophoretic Displays by Roll-to-Roll Manufacturing processes” by R. C. Liang et all, SiPix Imaging, Inc. in Proceedings of the Ninth International Display Workshop 2002 (IDW'02), pages 1337 to 1340.

In the roll-to-roll process disclosed, a layer which comprises a plastic substrate PS on which a transparent patterned conductor TC is present is inputted into the production machine which moves this layer to the output. Along the line of movement, the layer is processed. At step ST1, the transparent conductor of the layer is coated with a radiation curable resin composition RC. In step ST2, the resin is embossed and hardened to obtain the microcups MC. At step ST3, the microcups MC are filled with an electrophoretic fluid. At step ST4, the microcups MC are sealed with a sealing layer. And at step ST5, the layer with the sealed microcups MC is laminated and cut. This prior art further discloses that a further patterned conductor film is applied (not shown in FIG. 6) such that the microcups MC are sandwiched between two patterned conductor films forming crossing electrodes which generate the field perpendicular to the plane of the display.

The electrode structures in accordance with the invention of which embodiments are shown in FIG. 3B and FIG. 4B can be easily produced with this simple and inexpensive roll-to-roll process (or other low-cost manufacturing such as, for example, printing based) because all structures which need to have a small tolerance are made in the same step. The simple one-dimensional lines or blocks of FIGS. 4A and 4B are especially easy to produce with these low-cost manufacturing processes.

It should be noted that the above-mentioned embodiments illustrate rather than limit the invention, and that those skilled in the art will be able to design many alternative embodiments without departing from the scope of the appended claims.

Electrophoretic display panels can form the basis of a variety of applications where information may be displayed, for example in the form of information signs, public transport signs, advertising posters, pricing labels, billboards etc. In addition, they may be used where a changing non-information surface is required, such as wallpaper with a changing pattern or color, especially if the surface requires a paper like appearance.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Method of manufacturing an interleaving electrode structure of a first group of electrodes (G1) and a second group of electrodes (G2) for pixels (10) of a passive matrix in-plane switching bi-stable display (1), the pixels (10) being associated with intersections of first electrodes (20) and second electrodes (30), the method comprises the steps of:
(i) providing on a same substrate both the first electrodes (20) and, per pixel (10), the first group of electrodes (G1) and the second group of electrodes (G2), wherein electrodes of said first and second group extend in substantially a same first direction, and are displaced with respect to each other in the first direction to obtain in the first direction a first area (A1) where only electrodes of said first group (G1) are present, a second area (A2) where only electrodes of said second group (G2) are present, and a third area (A3) in-between the first and the second area (A1, A2) where both electrodes of said first and second group (G1, G2) are present,
(ii) providing the second electrodes (30) each extending in a second direction and being positioned for contacting the second group of electrodes (G2) in the second area (A2),
(iii) providing an insulating area (40) at least at crossing positions where the second electrodes (30) have to cross the first electrodes (20), and
providing during the step (i) or (ii) sub-electrodes (S1) per pixel (10) in the second direction for interconnecting the first group of electrodes (G1) in the first area (A1) and for connecting said first group of electrodes (G1) to an associated one of the first electrodes (20).

2. Method of manufacturing as claimed in claim 1, wherein the method performs successively the steps (i), (iii) and (ii) wherein during the step (iii) the insulating area (40) is provided on the same substrate above the first electrodes at least the crossing positions, and wherein during the step (ii) the second electrodes are provided on the same substrate above the second group of electrodes (G2) and above the insulating area (40).

3. Method of manufacturing as claimed in claim 1, wherein during the step (ii) the second electrodes (30) are provided on a further substrate, and wherein during the step (iii) the insulating area is either provided on the first electrodes (20) or on the second electrodes (30) at least at the crossing positions, and wherein the first mentioned and the further substrate are stacked.

4. Method as claimed in claim 1, wherein the step of providing the sub-electrodes (S1) per pixel (10) is applied during the step (i) by providing the sub-electrodes (S1) on the substrate forming one structure with the electrodes of said first group (G1) and the associated one of the first electrodes (20).

5. Method as claimed in claim 2 wherein the step of providing said first group of electrodes (G1) provides a first group of electrodes (G1) being substantially parallel arranged line shaped sections only, and the step of providing the sub-electrodes (S1) per pixel (10) is applied during the step (iii) by providing the sub-electrodes (S1) in the first area (A1) to electrically interconnect the parallel arranged line shaped sections, and to electrically connect the interconnected parallel arranged line shaped sections to the associated one of the first electrodes (20).

6. Method as claimed in claim 1, wherein a dimension of the first area (A1) in the first direction is larger than a width (W1) of an associated one of the sub-electrodes (S1).

7. Method as claimed in claim 1, wherein the step of providing said second group of electrodes (G2) is applied during the step (i) by providing said second group of electrodes (G2) together with a section (S2) extending in the second direction and being located in the second area (A2) for forming one structure with the electrodes of said second group (G2) per pixel (10), said section (S2) does not electrically connect to the associated one of the first electrodes (20), and wherein the associated one of the second electrodes (30) provided during the step (iii) electrically contacts said section (S2).

8. Method as claimed in claim 5, wherein a width of said section (S2) in the first direction is larger than a width (W2) of an associated one of the second electrodes (30).

9. Method as claimed in claim 2, wherein the step of providing said second group of electrodes (G2) provides a second group of electrodes (G2) being substantially parallel arranged line shaped sections only, and in that the step of providing the second electrodes (30) interconnects said parallel arranged line shaped sections in the second area (A2).

10. Method as claimed in claim 3, wherein the step of providing said second group of electrodes (G2) provides a second group of electrodes (G2) being substantially parallel arranged line shaped sections only, and in that the step of stacking said first mentioned and the further substrate interconnects said parallel arranged line shaped sections in the second area (A2).

11. Method as claimed in claim 7, wherein a dimension of the second area (A2) in the first direction is larger than a width (W2) of an associated one of the second electrodes (30).

12. A passive matrix in-plane switching bi-stable display (1) having first electrodes (20) and second electrodes (30), pixels (10) being associated with intersections of the first electrodes (20) and the second electrodes (30), said display (1) comprises:
(i) on a same substrate both the first electrodes (20) and, per pixel (10), a first group of electrodes (G1) interleaving with a second group of electrodes (G2), wherein electrodes of said first and second group (G1, G2) extend in substantially a same first direction, and are displaced with respect to each other in the first direction to obtain in the first direction a first area (A1) where only electrodes of said first group (G1) are present, a second area (A2) where only electrodes of said second group (G2) are present, and a third area (A3) in-between the first and the second area (A1, A2) where both electrodes of said first and second group (G1, G2) are present,
(ii) insulating areas (40) at least at crossing positions where the second electrodes (30) have to cross the first electrodes (20),
(iii) the second electrodes (30) extend in a second direction and are positioned for crossing the first electrodes (20) at the crossing positions and for contacting the second group of electrodes (G2) in the second area (A2), and
sub-electrodes (S1) per pixel (10) arranged in the second direction for interconnecting the first group of electrodes (G1) in the first area and for connecting said first group (G1) to an associated one of the first electrodes (20).
